(19) United States
(12) Patent Application Publication
(10) Pub. No.: US 2003/0006891 A1
(43) Pub. Date: Jan. 9, 2003

(54) Method, computer program and device for monitoring a vacuum device

(76) Inventors: Ernst Wild, Oberriexingen (DE); Kristina Eberle, Hardthof (DE); Lutz Reuschenbach, Stuttgart (DE)

Correspondence Address: Striker Striker & Stenby, 103 East Neck Road, Huntington, NY, 11743, US

(21) Appl. No.: 10/089,622

(22) PCT Filed: Jul. 3, 2001
(86) PCT No.: PCT/DE01/02450

(51) Int. Cl. B60Q 1/00

(52) U.S. Cl. 340/438; 340/451; 340/611; 340/614; 417/44.2; 417/44.3

(57) ABSTRACT

A vacuum chamber (22) of a pneumatically operated servo unit (30) of a motor vehicle is subjected to vacuum by an electric suction pump (28). In order to monitor the vacuum chamber (22) and the electric suction pump (28), the invention proposes that a starting pressure in the vacuum chamber (22) be determined. In addition, after a certain time interval, an ending pressure in the vacuum chamber (22) is determined. Furthermore, the difference between the ending pressure and the starting pressure is calculated and compared to a limit value. If this difference falls below the limit value, a signal is generated, in particular a warning and/or alarm signal.

### PRIOR ART

The current invention relates to a method for monitoring a vacuum device of a pneumatically operated servo unit of a motor vehicle in which an electric suction pump exerts vacuum on a vacuum chamber.

A method of the type mentioned at the beginning is used, for example, to monitor the vacuum device of a brake booster. Usually, the vacuum in the vacuum chamber is in fact taken from an intake tube of the internal combustion engine; in certain cases, it is possible that the existing vacuum in the intake tube of the internal combustion engine is not sufficient to produce enough vacuum in the vacuum chamber to operate the servo unit. For these cases, an electric suction pump is provided, which can be switched on in order to correspondingly act on the vacuum chamber.

If the suction pump fails or if a leakage occurs in the system, this could up till now only be detected by means of additional sensors, which also detect the pressure, for example, in the electric suction pump. Sensors of this kind, though, are expensive and are themselves susceptible to malfunction.

The object of the current invention, therefore, is to modify a method of the type mentioned at the beginning such that it is possible to monitor the vacuum chamber in a reasonably priced, reliable manner.

The object is attained by virtue of the fact that

a) a starting pressure in the vacuum chamber is determined;

b) after a predetermined time interval, an ending pressure in the vacuum chamber is determined;

c) the difference between the ending pressure and the starting pressure is calculated and is compared to a limit value;

d) when this difference falls below the limit value, a signal is generated.

### ADVANTAGES OF THE INVENTION

The method according to the invention determines the pressure drop occurring in the vacuum chamber, which is caused by the operation of the electric suction pump. If this pressure drop does not achieve a particular value, then it can be assumed that a malfunction is occurring either inside the electric suction pump or inside the fluid connection between the vacuum chamber and the electric suction pump, or there is a leak, for example, in the vacuum chamber itself. In this instance, a signal is generated, which can be used to initiate suitable measures. The method according to the invention consequently permits a monitoring of the function of the electric suction pump, the fluid connection, and the vacuum chamber without requiring an additional sensor. This can reduce costs considerably, particularly in mass production.

Advantageous modifications of the method according to the invention are disclosed in the dependent claims.

In claim 2, the method is modified such that the limit value is determined as a function of the starting pressure in the vacuum chamber. This procedure is based on the knowledge that the suction characteristic curve of the electric suction pump does not progress in linear fashion, but generally progresses in exponential fashion. If the starting pressure in the vacuum chamber is already relatively low, then in the given time interval, the electric suction pump can only produce less of a pressure drop than is possible with a relatively high starting pressure. The modification in claim 2 takes this into account, which increases the monitoring precision and prevents an unnecessary initiation of corresponding measures.

A similar aim is sought by the modification according to claim 3, according to which the limit value is established as a function of the ambient pressure. This takes into account the fact that the pump capacity of the electric suction pump is a function of the ambient pressure, which likewise improves the reliability of the monitoring of the vacuum device.

With the method disclosed in claim 4, the limit value is determined as a function of the difference between the ambient pressure and the starting pressure. The difference between the ambient pressure and the starting pressure is a particularly important value for the pump capacity of the electric suction pump so that with this modification, the monitoring operates in a particularly reliable manner.

It is advantageous if, according to claim 5, the starting pressure is determined as soon as the suction pump is switched on. This assures that the calculation of the difference between the ending pressure and the starting pressure uses a relatively high starting pressure, at which the pump capacity of the electric suction pump is better for the above-mentioned reasons so that a better reliability of the monitoring is also achieved.

Claim 6 discloses a possible use for the signal generated, namely the triggering of a control or alarm device (e.g. a warning lamp).

However, there are also conceivable conditions in which the prerequisites for triggering a control or alarm device have in fact been fulfilled, but certain circumstances have rendered the basis for this triggering unwarranted. According to claim 7, the existence of such an unwarranted basis will be assumed if at least one of the following conditions is fulfilled:

a) the pressure in an intake tube of an internal combustion engine, which intake tube is connected to the vacuum chamber, is lower than the pressure in the vacuum chamber;

b) the servo unit is actuated; and/or

c) the pressure in the vacuum chamber is lower than the minimal possible pressure in the electric suction pump plus a threshold value.

In claims 8 and 9, the current invention also relates to a computer program, which is suitable for executing the method according to one of claims 1 to 7 when it is run on a computer. It is particularly preferable if it is stored in a memory, in particular a flash memory.

Claim 10 mentions a device for monitoring a vacuum device of a pneumatically operated servo unit of a motor vehicle, with a vacuum chamber that is fluid-connected to an electric suction pump and can be acted on with vacuum. The invention provides that

a) it detects a starting pressure in the vacuum chamber (22);

b) after a certain time interval, it detects an ending pressure in the vacuum chamber (22);

c) it calculates the difference between the ending pressure and the starting pressure and compares this to a limit value; and

d) when this difference falls below the limit value, it generates a signal.

The embodiment according to claim 11 provides that the device includes:

a) means for determining the pressure in the vacuum chamber;

b) means for detecting the beginning of an evacuation process;

c) a timer, which determines the time elapsed since the beginning of the evacuation process;

d) means for storing the starting pressure at the beginning of the evacuation process;

e) a subtraction circuit, which calculates the difference between the starting pressure and the current pressure in the pressure chamber;

f) two set point generators, one of which predetermines a time interval and the other of which predetermines a minimal value for the difference between the starting pressure and the current pressure in the pressure chamber; and

g) a comparator, which generates a signal if the difference is less than the minimal value after the passage of the time interval.

A device of this kind can execute the method disclosed in claim 1 with particular ease.

According to claim 12, the beginning of an evacuation process is detected by providing a device, which detects a signal edge that represents the response of the pump. A device of this kind is simple to embody using only conventional electronic circuits.

Other advantageous modifications of the device according to the invention are contained in claims 13 to 15.

### DRAWINGS

Two exemplary embodiments of the invention will be explained in detail below in conjunction with the accompanying drawings.

FIG. 1 shows a vacuum device of a servo unit and a device for monitoring it;

FIG. 2 shows a process chart of a first exemplary embodiment of a method that can be used for monitoring the device shown in FIG. 1; and

FIG. 3 shows a process chart of a second exemplary embodiment similar to the one in FIG. 2.

### DESCRIPTION OF THE EXEMPLARY EMBODIMENTS

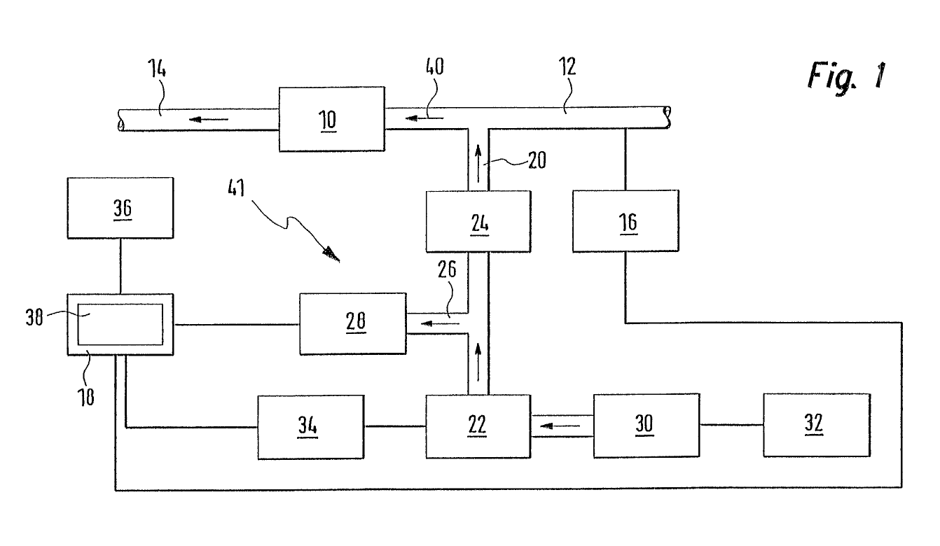

In FIG. 1, an internal combustion engine is labeled with the reference numeral 10. It is supplied with air (arrow 40) from an intake line 12 and the exhaust gases are carried off by means of an exhaust line 14. The pressure in the intake line 12 is measured by a pressure sensor 16, which uses a data line (no reference numeral) to send signals to a set of control electronics 18.

A vacuum chamber 22 is fluid-connected to the intake tube 12 by means of a suction line 20. Between the vacuum chamber 22 and the intake tube 12, a check valve 24 is provided, which permits a flow only from the vacuum chamber 22 to the intake tube 12.

Between the vacuum chamber 22 and the check valve 24, a branch line 26 leads from the suction line 20 to an electric suction pump 28. This pump in turn is controlled by the control electronics 18 via a control line (no reference numeral).

The vacuum chamber 22 is fluid-connected to a brake booster 30, which represents a servo unit and is actuated by a brake pedal 32. The pressure in the vacuum chamber 22 is measured by a pressure sensor 34, which sends corresponding signals to the control electronics 18.

The air flows and their directions are indicated by arrows 40. The vacuum device, which is comprised of the vacuum chamber 22, the suction line 20, the branch line 26, and the electric suction pump 28, is labeled as a whole with the reference numeral 41.

Finally, an ambient pressure sensor 36 is also provided, which is likewise connected by the control electronics 18 via a signal line (no reference numeral). The control electronics 18 include a read only memory (ROM) 38, in which a program is stored, which is used to monitor the vacuum device 41 shown in FIG. 1. Alternatively, a flash memory could also be provided.

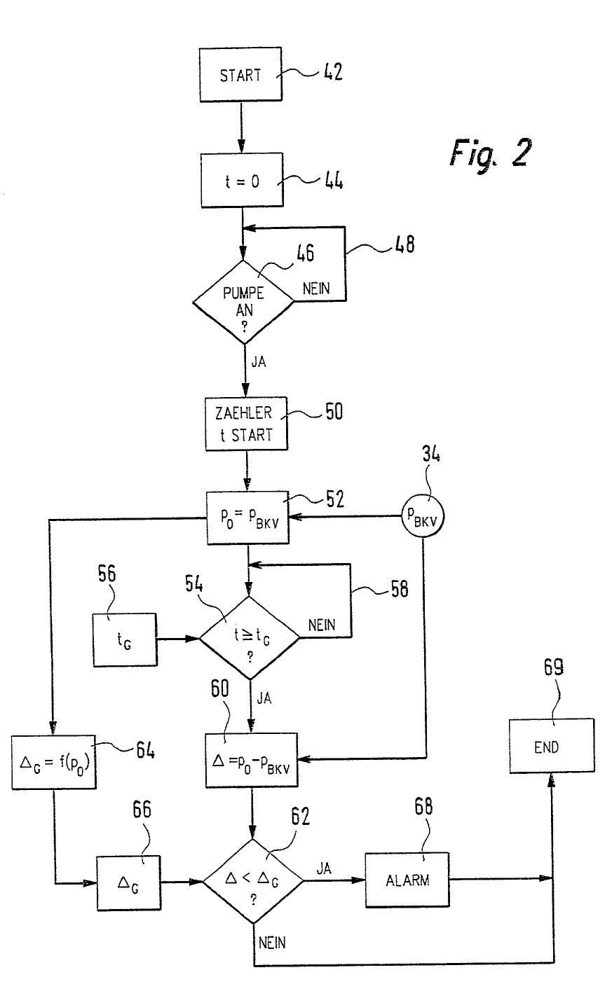

An example for such a program is shown in FIG. 2:

The entry into the program is represented by the starting block 42. After the starting block, a counter for a time interval t is set to 0 (block 44). Then in block 46, a test is run as to whether the electric suction pump 28 is switched on. If the electric suction pump 28 is switched off, the program remains in a wait loop 48. However, if the answer to the query in block 46 is positive, then in block 50, a counter is started, which counts the passage of time once the pump 28 is switched on.

In addition, the pressure p_{BKV} prevailing in the vacuum chamber 22, which is measured by the pressure sensor 34 at the time when the electric suction pump 28 is switched on, is stored in a memory in block 52. This starting pressure is labeled p₀.

Then in block 54, a query is made as to whether the counter t, which was started in block 50 and counts the time elapsed since the electric suction pump 28 was switched on, has reached or exceeded a limit value t_{G}. The limit value t_{G} is provided by a limit value generator 56. If the time interval established by the limit value t_{G} has not yet elapsed, then the process remains in a wait loop 58. As soon as the established time t_{G} has elapsed or been exceeded, then in block 60, the difference Δ between the starting pressure p₀ and the current pressure p_{BKV} in the vacuum chamber 22 is calculated. The current pressure p_{BKV} is determined by the pressure sensor 34.

Then in block 62, a query is made as to whether the difference Δ calculated in block 60 is less than a minimal value Δ_{G}. The minimal value Δ_{G} is not a set value, but rather a variable value, which is calculated in block 64 as a function of the starting pressure p₀. It represents the minimal pressure that is achieved with an intact suction pump 28. The function f(p₀), which is used to determine the minimal value Δ_{G}, is selected so that when the starting pressure p₀ is already relatively low and consequently the electric suction pump 28 is no longer operating in the optimal operating range, the minimal value Δ_{G} is smaller than in the opposite case. The minimal value Δ_{G} is stored in a set point memory 66 that represents a set point generator.

If the result of the query in block 62 is positive, this means that the pressure drop Δ in the predetermined time t_{G} was less than the minimal required value Δ_{G}. Since this permits the conclusion to be drawn that there is a malfunction of the electric suction pump 28 or there is a leakage either inside the fluid connection between the vacuum chamber 22 and electric suction pump 28 or a leakage in the vacuum chamber itself, a bit is then set, which in block 68 causes an alarm signal to be given off.

Subsequently, or in the event of a negative query result in block 62, the process ends in block 69. From there, it is possible to return to the starting block 42 if need be, as dictated by events. This return can also be provided on a regular basis with a particular cycle frequency.

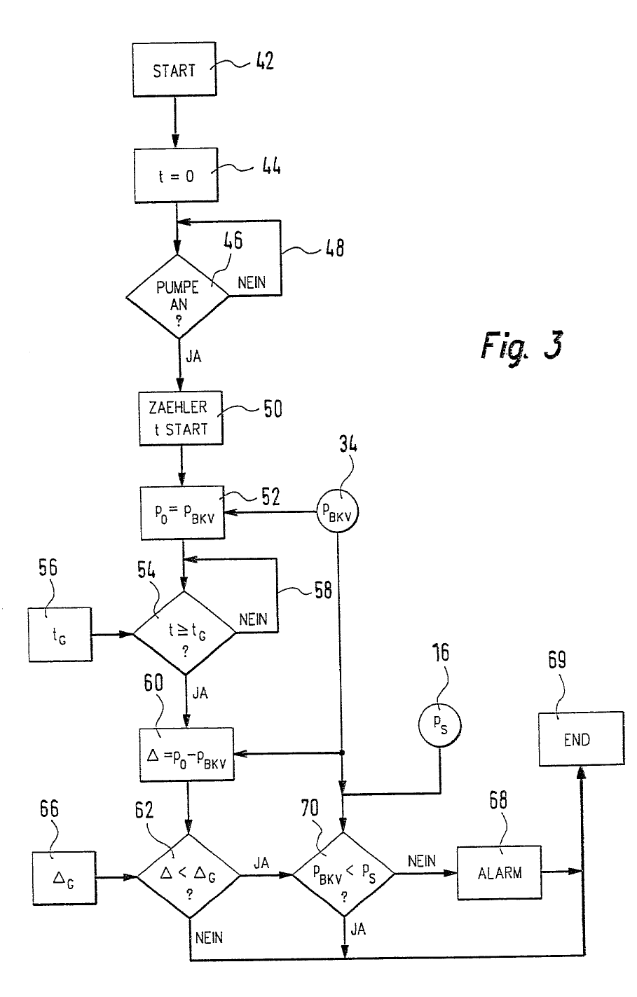

In the process chart shown in FIG. 3, blocks which have functions equivalent to the same blocks in FIG. 2 are provided with the same reference numerals. The two essential differences in relation FIG. 2 will now be discussed:

On the one hand, in the exemplary embodiment shown in FIG. 3, the minimal value Δ_{G} in block 66 is no longer a variable value, but is instead a set value, i.e. the minimal value Δ_{G} is not adapted to the starting pressure p₀.

In addition, with a positive query result in block 62, an alarm signal is not generated immediately; first, a query is made in block 70 as to whether the actual pressure p_{BKV} in the vacuum chamber 22 is lower than the pressure in the intake tube 12, which is detected by the pressure sensor 16 and is supplied to the block 70. If the query result in block 70 is positive, i.e. the pressure prevailing in the intake tube 12 is actually lower than the pressure p_{BKV} prevailing in the vacuum chamber 23, then this means that the check valve 24 opens and the vacuum chamber 22, the suction line 20, the branch line 26, and therefore also the electric suction pump 28 are fluid-connected to the intake tube 12. This influences the pressure p_{BKV} in the vacuum chamber 22 so that no reliable conclusion can be reached with regard to the interrelationship between the operation of the electric suction pump 28 and the pressure drop in the vacuum chamber 22. Therefore an alarm signal is not triggered in this instance.

However, if the pressure p_{S} in the intake tube 12 is greater than the pressure p_{BKV} in the vacuum chamber 22, then the check valve 24 remains closed and it can be assumed that there is a malfunction inside the vacuum device 41. Therefore in this instance, an alarm signal is triggered in block 18.

In an exemplary embodiment it is not shown, in block 70, a query is not made as to whether the pressure p_{BKV} in the vacuum chamber 22 is lower than the pressure p_{S} prevailing in the intake tube 12, but rather a query is made as to whether the servo unit, i.e. the brake booster 30, is being actuated by means of the brake pedal 32. This can be carried out, for example, by checking whether or not the brake light is illuminated. In addition, in block 70, a query can also be made as to whether the pressure p_{BKV} in the vacuum chamber 22 is lower than the minimal possible pressure in the electric suction pump 28 plus a threshold value. The minimal possible pressure in the electric suction pump 28 in turn is a function of the ambient pressure, which is detected by the sensor 36, and is also a function of the properties of electric suction pump 28 itself.

1. A method for monitoring a vacuum device of a pneumatically operated servo unit of a motor vehicle, in which an electric suction pump (28) exerts vacuum on a vacuum chamber (22), characterized in that
a) a starting pressure in the vacuum chamber (22) is determined;
b) after a predetermined time interval, an ending pressure in the vacuum chamber (22) is determined;
c) the difference between the ending pressure and the starting pressure is calculated and is compared to a limit value;
d) when this difference falls below the limit value, a signal is generated.

2. The method according to claim 1, characterized in that the limit value is determined as a function of the starting pressure in the vacuum chamber (22).

3. The method according to one of claims 1 or 2, characterized in that the limit value is determined as a function of the ambient pressure.

4. The method according to claims 2 and 3, characterized in that the limit value is determined as a function of the difference between the ambient pressure and starting pressure.

5. The method according to one of the preceding claims, characterized in that the starting pressure is determined as soon as the suction pump (28) is switched on.

6. The method according to one of the preceding claims, characterized in that the signal generated triggers a control or alarm device.

7. The method according to claim 6, characterized in that the triggering of the control or alarm signal is suppressed if at least one of the following conditions is fulfilled:
a) the pressure in an intake tube (12) of an internal combustion engine, which intake tube is connected to the vacuum chamber (22), is lower than the pressure in the vacuum chamber (22);
b) the servo unit (30) is actuated; and/or
c) the pressure in the vacuum chamber (22) is lower than the minimal possible pressure in the electric suction pump (28) plus a threshold value.

8. A computer program, characterized in that it is suitable for executing the method according to one of claims 1 to 7 when it is run on a computer.

9. The computer program according to claim 8, characterized in that it is stored in a memory, in particular a flash memory.

10. An apparatus for monitoring a vacuum storage device (41) of a pneumatically operated servo unit (30) of a motor vehicle, with a vacuum chamber (22), which is fluid-connected to an electric suction pump (28) and can be acted upon with a vacuum, characterized in that
a) it detects a starting pressure in the vacuum chamber (22);
b) after a certain time interval, it detects an ending pressure in the vacuum chamber (22);
c) it calculates the difference between the ending pressure and the starting pressure and compares this to a limit value; and
d) when this difference falls below the limit value, it generates a signal.

11. The apparatus according to claim 10, characterized in that it includes:
a) means (34) for determining the pressure in the vacuum chamber (22);
b) means (46) for detecting the beginning of an evacuation process;
c) a timer (54), which determines the time elapsed since the beginning of the evacuation process;
d) means (52) for storing the starting pressure at the beginning of the evacuation process;
e) a subtraction circuit (60), which calculates the difference between the starting pressure and the current pressure in the pressure chamber (22);
f) two set point generators (56, 66), one of which predetermines a time interval and the other of which predetermines a minimal value for the difference between the starting pressure and the current pressure in the pressure chamber (22); and
g) a comparator (62), which generates a signal if the difference is less than the minimal value after the passage of the time interval.

12. The apparatus according to claim 11, characterized in that the means (46) for detecting the beginning of an evacuation process include a device, which detects a signal edge that represents the response of the pump (28).

13. The apparatus according to one of claims 10 to 12, characterized in that it includes a calculation circuit (64), which is connected on the input side to the means for storing the starting pressure and/or means for detecting the ambient pressure, and in which a function is processed so that the limit value is determined as a function of the starting pressure, the ambient pressure, and/or the difference between the starting pressure and the ambient pressure.

14. The apparatus according to one of claims 10 to 13, characterized in that it has a signal generator (68), which triggers a control and/or alarm signal when the signal is generated by the comparator (62).

15. The apparatus according to claim 14, characterized in that it includes means (70), which suppress the generation of a control or alarm signal if at least one of the following conditions is fulfilled:
a) the pressure in an intake tube (12) of an internal combustion engine (10), which intake tube is connected to the vacuum chamber (22), is lower than the pressure in the vacuum chamber (22);
b) the servo unit (30) is actuated; and/or
c) the pressure in the vacuum chamber (22) is lower than the minimal possible pressure in the electric suction pump (28) plus a threshold value.
